(19) United States
(12) Patent Application Publication
(10) Pub. No.: US 2026/0358572 A1
(43) Pub. Date: Nov. 12, 2026

(54) OPTICAL CONNECTION COMPONENT AND METHOD FOR MANUFACTURING OPTICAL CONNECTION COMPONENT

(71) Applicant: SUMITOMO ELECTRIC INDUSTRIES, LTD., Osaka (JP)

(72) Inventors: Yushi HAMAYAMA, Osaka (JP); Tetsuya NAKANISHI, Osaka (JP)

(73) Assignee: SUMITOMO ELECTRIC INDUSTRIES, LTD., Osaka (JP)

(21) Appl. No.: 19/661,800

(22) Filed: Apr. 29, 2026

(30) Foreign Application Priority Data
May 8, 2025 (JP) 2025-077939

(51) Int. Cl. G02B 6/38

(52) U.S. Cl. CPC G02B 6/3882; G02B 6/3854

(57) ABSTRACT

An optical connection component according to one embodiment includes a glass component having a front surface extending in a first direction and a second direction intersecting the first direction. The glass component has a hole portion recessed from the front surface in a third direction intersecting the first direction and the second direction. The optical connection component includes a resin layer formed on an inner surface of the glass component that defines the hole portion.

### CROSS REFERENCE TO RELATED APPLICATIONS

This application claims priority based on Japanese Patent Application No. 2025-077939 filed on May 8, 2025, and the entire contents of the Japanese patent application are incorporated herein by reference.

### TECHNICAL FIELD

The present disclosure relates to an optical connection component and a method for manufacturing an optical connection component.

### BACKGROUND

PCT International Publication No. WO 2020/027125 describes an optical connection component including a plurality of fiber ribbons and a fiber fixing component. The fiber fixing component includes a multi-hole glass plate and a multi-hole resin ferrule. The multi-hole glass plate is fixed to an electronic substrate, and the multi-hole resin ferrule is interposed between the multi-hole glass plate and the plurality of fiber ribbons. The multi-hole glass plate has a through-hole into which the glass fiber of the fiber ribbon is inserted, and a guide hole into which a guide pin is inserted.

Japanese Unexamined Patent Publication No. 2022-64875 describes a method for processing glass through alkaline etching. In this method, the glass is processed using a laser processing apparatus including an ultrashort pulse laser and a positioning device. The ultrashort pulse laser irradiates a glass element with a laser beam to introduce rectangular scratches into the glass element. Thereafter, the glass element is etched. The scratches are connected by the etching, and a rectangular portion is removed from the glass element.

### SUMMARY

An optical connection component according to the present disclosure includes a glass component having a front surface extending in a first direction and a second direction intersecting the first direction. The glass component has a hole portion recessed from the front surface in a third direction intersecting the first direction and the second direction. The optical connection component includes a resin layer formed on an inner surface of the glass component that defines the hole portion.

### BRIEF DESCRIPTION OF THE DRAWINGS

FIG. 1 is a perspective view illustrating an optical connection component according to an embodiment.

FIG. 2 is a cross-sectional view illustrating the optical connection component according to the embodiment.

FIG. 3 is a view illustrating steps of a method for manufacturing an optical connection component according to an embodiment.

FIG. 4 is a view illustrating steps of the method for manufacturing an optical connection component according to the embodiment.

FIG. 5 is a cross-sectional view illustrating an optical connection component according to a modification example.

FIG. 6 is a cross-sectional view illustrating an optical connection component according to a modification example different from that of FIG. 5.

### DETAILED DESCRIPTION

By the way, when a hole is formed in a glass component by laser beam irradiation and etching, it may be difficult to control the shape of the hole with high accuracy. When a guide pin or the like comes into contact with the glass component, cracks may occur in the glass component. Therefore, it is required to control the shape of the hole with high accuracy and make cracks less likely to occur.

An object of the present disclosure is to provide an optical connection component and a method for manufacturing an optical connection component that enable the shape of a hole to be controlled with high accuracy and enable cracks to be less likely to occur.

According to the present disclosure, the shape of a hole can be controlled with high accuracy, and cracks can be made less likely to occur.

First, embodiments of an optical connection component and a method for manufacturing an optical connection component according to the present disclosure will be listed and described. (1) An optical connection component according to one embodiment includes a glass component having a front surface extending in a first direction and a second direction intersecting the first direction. The glass component has a hole portion recessed from the front surface in a third direction intersecting the first direction and the second direction. The optical connection component includes a resin layer formed on an inner surface of the glass component that defines the hole portion.

In the optical connection component, the glass component has the front surface extending in the first direction and the second direction, and the hole portion recessed from the front surface in the third direction. The optical connection component includes the resin layer. The resin layer is formed on the inner surface of the glass component that defines the hole portion. The shape of a hole of the optical connection component can be controlled with high accuracy by forming the resin layer on the inner surface of the hole portion of the glass component. Even if the shape of the hole portion of the glass component cannot be controlled with high accuracy by laser beam irradiation and etching, the hole of the optical connection component can be formed with high accuracy by covering the inner surface of the hole portion of the glass component with the resin layer. Since the hole portion of the glass component can be protected by covering the inner surface of the hole portion of the glass component with the resin layer, cracking of the glass component can be made less likely to occur.

(2) In (1) above, an inner surface of the hole portion of the glass component may be inclined with respect to the third direction such that, as viewed along the third direction, an area of the hole portion decreases as the hole portion extends away from the front surface. An inner surface of the resin layer may extend in the third direction. In this case, even if the inner surface of the hole portion of the glass component is inclined with respect to the third direction, the inner surface of the resin layer covering the hole portion extends in the third direction. Therefore, the shape of the hole of the optical connection component can be controlled such that the hole extends in the third direction.

(3) In (1) or (2) above, the resin layer may have a tapered surface that is a portion inclined with respect to the third direction such that, as viewed along the third direction, an area of the inner surface of the resin layer decreases as the resin layer extends away from the front surface. In this case, since the area of the inner surface of the resin layer increases as the resin layer approach the front surface, a guide pin or the like can be easily inserted from the front surface.

(4) In any one of (1) to (3) above, a surface roughness of the resin layer may be 1 μm or less. In this case, since the shape of the hole of the optical connection component formed by the resin layer can be stabilized, the accuracy of positioning when a guide pin or the like is inserted into the hole can be enhanced.

(5) In any one of (1) to (4) above, a surface roughness of the glass component may be 0.5 μm or more and 10 μm or less. Since the surface roughness of the glass component is 0.5 μm or more, the resin layer can easily adhere to the hole portion of the glass component. Since the surface roughness of the glass component is 10 μm or less, the flatness of the hole portion of the glass component can be ensured. Therefore, the occurrence of regions in which the resin layer does not adhere due to unevenness of the inner surface of the hole portion can be reduced.

(6) In any one of (1) to (5) above, a thickness of the resin layer may be 30 μm or more and 1000 μm or less. Since the thickness of the resin layer is 30 μm or more, the shape of the hole of the optical connection component can be controlled with high accuracy, and the glass component can be sufficiently protected. Since the thickness of the resin layer is 1000 μm or less, a change in the position of a guide pin or the like inserted into the hole of the optical connection component can be more reliably reduced.

(7) In any one of (1) to (6) above, a coefficient of linear expansion of the resin layer may be 3×10⁻⁶ [/°C] or more and 100×10⁻⁶ [/°C] or less. In this case, thermal expansion of the optical connection component is prevented, so that the positional accuracy of the optical connection component by a guide pin or the like can be enhanced.

(8) A method for manufacturing an optical connection component according to the present disclosure includes a step of forming a hole portion recessed from a front surface of a glass component by irradiating the glass component with an ultrashort pulse laser; and a step of forming a resin layer on an inner surface defining the hole portion. In the method for manufacturing an optical connection component, the hole portion is formed in the glass component, and the resin layer is formed on the inner surface of the glass component that defines the hole portion. The shape of a hole of the optical connection component can be controlled with high accuracy by forming the resin layer on the inner surface of the hole portion of the glass component. Even if the shape of the hole portion of the glass component cannot be controlled with high accuracy by laser beam irradiation and etching, the hole of the optical connection component can be formed with high accuracy by covering the inner surface of the hole portion of the glass component with the resin layer. Therefore, similarly to the optical connection component described above, the hole portion of the glass component can be protected by covering the inner surface of the hole portion of the glass component with the resin layer, so that cracking of the glass component can be made less likely to occur.

(9) In (8) above, in the step of forming the resin layer, the resin layer may be formed on the inner surface by insert molding. In this case, the resin layer can be easily formed on the inner surface of the hole portion of the glass component.

Specific examples of an optical connection component and a method for manufacturing an optical connection component according to an embodiment of the present disclosure will be described below with reference to the drawings. In the description of the drawings, the same or corresponding elements are denoted by the same reference signs, and duplicate descriptions will be omitted as appropriate. The drawings may be depicted in a partially simplified or exaggerated manner for ease of understanding, and dimensional ratios and the like are not limited to those illustrated in the drawings.

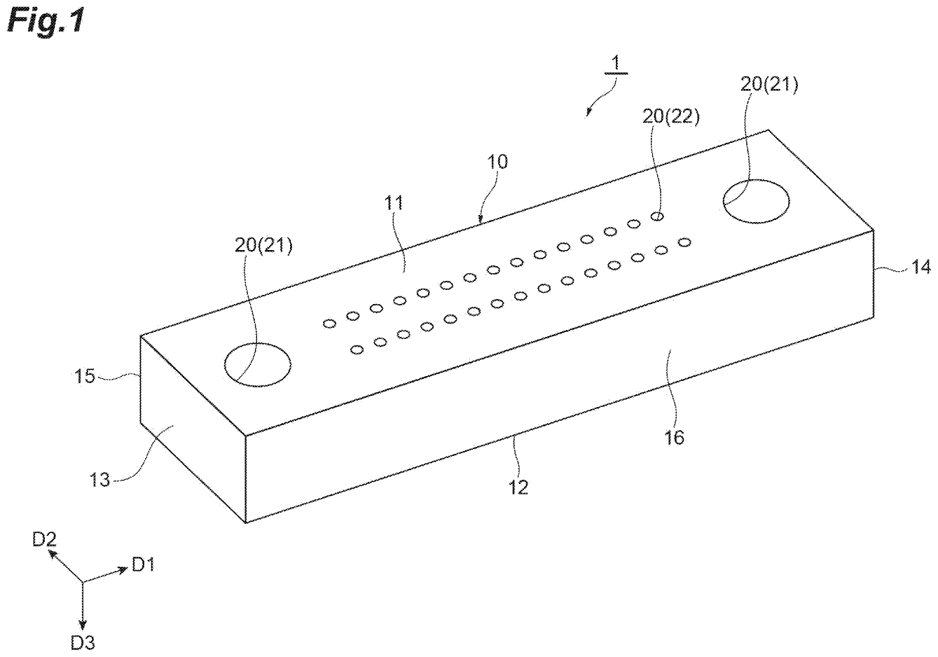

FIG. 1 is a perspective view illustrating an optical connection component 1 as one example according to the present embodiment. The optical connection component 1 has a configuration referred to as co-packaged optics (CPO), and is used, for example, in a data center, a high-performance computing environment, or the like. The optical connection component 1 is fixed to, for example, an electronic substrate. For example, an end portion of a fiber ribbon is fixed to the electronic substrate via the optical connection component 1.

The optical connection component 1 includes a glass component 10 having a front surface 11 extending in a first direction D1 and a second direction D2 intersecting the first direction D1. Glass has advantages such as good ultraviolet transmittance, high heat resistance, and a relatively small coefficient of linear expansion. The coefficient of linear expansion of glass is close to the coefficient of linear expansion of silicon. The glass component 10 has a rectangular parallelepiped shape. For example, the glass component 10 has a length in the first direction D1, a width in the second direction D2, and a thickness in a third direction D3 intersecting the first direction D1 and the second direction D2.

For example, the length of the glass component 10 in the first direction D1 is greater than the length of the glass component 10 in the second direction D2, and the length of the glass component 10 in the second direction D2 is greater than the length of the glass component 10 in the third direction D3. However, in the glass component 10, the relationship among the length in the first direction D1, the length in the second direction D2, and the length in the third direction D3 is not limited to the above-described example, and can be changed as appropriate.

For example, the surface roughness of the glass component 10 is 0.5 μm or more and 10 μm or less. In the present embodiment, the surface roughness is defined by an arithmetic mean roughness (Ra) which is a parameter representing surface roughness. The surface roughness is measured, for example, by a white light interferometric optical measurement instrument or a laser interferometric optical measurement instrument from Zygo Corporation, an image measuring system, NEXIV, manufactured by Nikon Corporation, an image measuring machine, UMAP Vision System, manufactured by Mitutoyo Corporation, or the like.

The glass component 10 has a back surface 12 opposite to the front surface 11; side surfaces 13 and 14 arranged along the first direction D1; and side surfaces 15 and 16 arranged along the second direction D2. The back surface 12 is, for example, a surface that is fixed to the electronic substrate. Each of the side surface 13 and the side surface 14 extends in the second direction D2 and the third direction D3, and each of the side surface 15 and the side surface 16 extends in the first direction D1 and the third direction D3. For example, the glass component 10 is a glass plate. The glass component 10 includes, for example, a glass material capable of transmitting ultraviolet light. The optical connection component 1 is fixed to the electronic substrate, for example, by an ultraviolet-curable adhesive.

The optical connection component 1 has a hole 20 recessed in the third direction D3 intersecting the first direction D1 and the second direction D2. For example, the hole 20 penetrates through the glass component 10 in the third direction D3. For example, the shape of the hole 20 as viewed along the third direction D3 is a circular shape. However, the shape of the hole 20 may be a rectangular shape, and the shape of the hole 20 is not particularly limited. The optical connection component 1 has a plurality of the holes 20. The plurality of holes 20 include, for example, a first hole 21 and a second hole 22.

The first hole 21 is a guide hole into which a guide pin for positioning the optical connection component 1 is inserted. The inner diameter of the first hole 21 is, as one example, 200 μm. The plurality of holes 20 include, for example, a plurality of the first holes 21 and a plurality of the second holes 22. The plurality of first holes 21 are arranged along the first direction D1. The area of each of the first holes 21 as viewed along the third direction D3 is greater than the area of each of the second holes 22 as viewed along the third direction D3.

An optical fiber is inserted into each of the second holes 22. The inner diameter of the second hole 22 is, as one example, 125 μm. For example, the glass fiber exposed at the end portion of the fiber ribbon described above is inserted into the second hole 22. The plurality of second holes 22 are formed between a pair of the first holes 21 arranged along the first direction D1. For example, on the front surface 11 of the glass component 10, a plurality of sets including the plurality of second holes 22 arranged along the first direction D1 are arranged along the second direction D2. An example of the disposition and aspects of the holes 20 on the front surface 11 has been described above. However, the disposition and aspects of the holes 20 are not limited to the above-described example, and can be changed as appropriate.

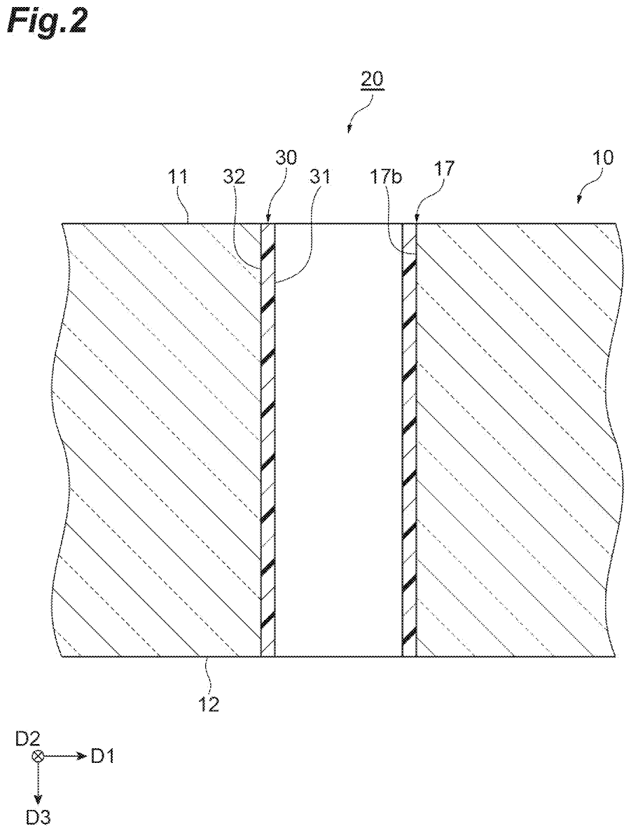

FIG. 2 is a cross-sectional view of the hole 20 taken along a plane extending in the first direction D1 and the third direction D3. As illustrated in FIG. 2, the glass component 10 has a hole portion 17 recessed from the front surface 11 in the third direction D3 intersecting the first direction D1 and the second direction D2. For example, the shape of the hole portion 17 as viewed along the third direction D3 is an annular shape (as one example, a circular annular shape).

The optical connection component 1 includes a resin layer 30 formed on an inner surface 17b of the glass component 10 that defines the hole portion 17. The inner surface 17b extends in the third direction D3 inside the glass component 10. The shape of the resin layer 30 as viewed along the third direction D3 is an annular shape (as one example, a circular annular shape). The resin layer 30 has an inner surface 31 facing the center of the resin layer 30 as the resin layer 30 is viewed along the third direction D3, and an outer surface 32 facing away from the center of the resin layer 30 as the resin layer 30 is viewed along the third direction D3. The outer surface 32 is in contact with the inner surface 17b defining the hole portion 17 of the glass component 10. In the present embodiment, the hole 20 of the optical connection component 1 is defined by the inner surface 31 of the resin layer 30.

The material of the resin layer 30 is, for example, polysilazane, siloxane, fluororesin, or ceramic. For example, the surface roughness of the resin layer 30 is greater than 0 μm and equal to or less than 1 μm. For example, the coefficient of linear expansion of the resin layer 30 is 3 ×10⁻⁶ [/°C] or more and 100×10⁻⁶ [/°C] or less. The resin layer 30 has, for example, a tubular shape (as one example, a cylindrical shape). Each of the inner surface 31 and the outer surface 32 extends in the third direction D3.

For example, the thickness of the resin layer 30 is 30 μm or more and 1000 μm or less. In the present embodiment, the thickness of the resin layer 30 indicates the thickness of the resin layer 30 as the resin layer 30 is viewed along the third direction D3. The thickness of the resin layer 30 may be 50 μm or less. Furthermore, the thickness of the resin layer 30 may be 100 μm or less. The upper limit of the thickness of the resin layer 30 may be 200 μm, 300 μm, 400 μm, or 500 μm.

A method for manufacturing an optical connection component according to the present embodiment will be described. Hereinafter, an example of a method for manufacturing the optical connection component 1 described above will be described. First, the glass component 10 is produced (a step of producing a glass component). At this time, the hole portion 17 recessed from the front surface 11 of the glass component 10 is formed by irradiating the glass component 10 with an ultrashort pulse laser (a step of forming a hole portion). More specifically, a portion of the glass in which the hole portion 17 is to be formed is irradiated with an ultrashort pulse laser to modify the portion, and thereafter, alkaline etching is performed to form the hole portion 17.

For example, the laser wavelength of the ultrashort pulse laser is 515 nm or 1030 nm, and the repetition frequency of the ultrashort pulse laser is 100 kHz or more and 1000 kHz or less. The pulse energy of the ultrashort pulse laser is 20 nJ or more and 2000 nJ or less, and the pulse width of the ultrashort pulse laser is 180 fs or more and 5000 fs or less. The material of an etching solution used during etching is, for example, hydrogen fluoride (HF), potassium hydroxide (KOH), or sodium hydroxide (NaOH). The etching time is, for example, 1 hour or more and 30 hours or less.

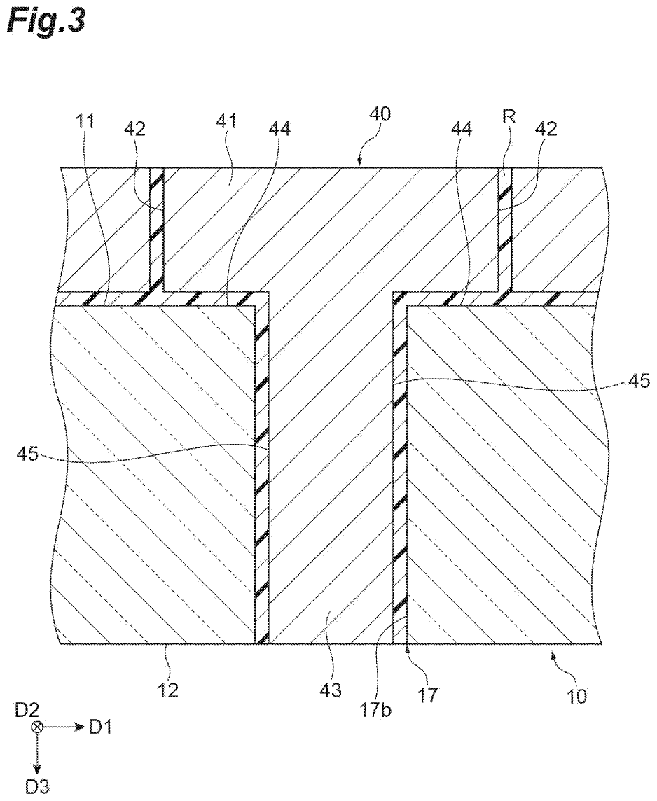

The resin layer 30 is formed on the inner surface 17b defining the hole portion 17 (a step of forming a resin layer). At this time, the resin layer 30 is formed on the inner surface 17b by insert molding. That is, a resin coating is applied to the inner surface 17b. As illustrated in FIG. 3, a mold 40 having a first portion 41 facing the front surface 11 of the glass component 10 and a second portion 43 protruding from the first portion 41 is prepared.

For example, the first portion 41 has a plate shape, and the second portion 43 has a columnar shape. The outer diameter of the second portion 43 is smaller than the inner diameter of the inner surface 17b. The second portion 43 is configured to be insertable into the hole portion 17. The second portion 43 forms a passage 45 for a resin R between the second portion 43 and the inner surface 17b when inserted into the hole portion 17. The outer diameter of the second portion 43 is designed such that the thickness of the passage 45 as viewed along the third direction D3 corresponds to the thickness of the resin layer 30 described above.

In a state in which the second portion 43 is inserted into the hole portion 17, a passage 44 for the resin R is formed between the front surface 11 and the first portion 41. The first portion 41 has a plurality of holes 42 for supplying the resin R to the passages 44 and 45. Each of the holes 42 penetrates through the first portion 41 in the third direction D3. When the resin R is supplied to the hole 42 in a state in which the second portion 43 is inserted into the hole portion 17, the passages 44 and 45 are filled with the resin R.

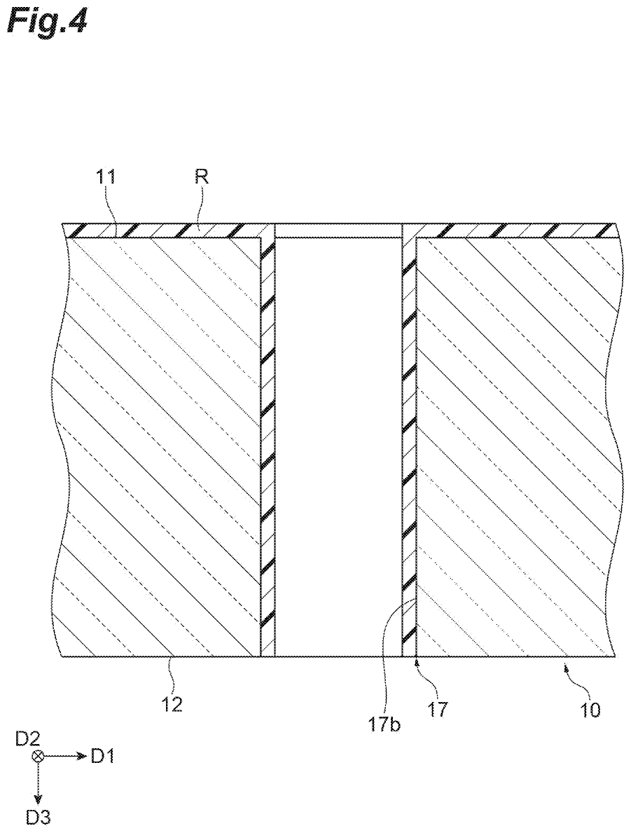

As illustrated in FIG. 4, the mold 40 is removed from the glass component 10 after the filled resin R is cured. For example, the resin R covering the front surface 11 of the glass component 10 is removed by polishing. It should be noted that the removal of the resin R covering the front surface 11 may not be necessary. When the resin R covering the front surface 11 of the glass component 10 is removed, the optical connection component 1 having the holes 20 illustrated in FIG. 2 is completed, and the series of steps is finished.

Effects obtained from the optical connection component 1 and the method for manufacturing an optical connection component according to the present embodiment will be described. In the optical connection component 1 and the method for manufacturing an optical connection component according to the present embodiment, the glass component 10 has the front surface 11 extending in the first direction D1 and the second direction D2, and the hole portion 17 recessed from the front surface 11 in the third direction D3. The optical connection component 1 includes the resin layer 30. The resin layer 30 is formed on the inner surface 17b of the glass component 10 that defines the hole portion 17. The shape of the hole 20 of the optical connection component 1 can be controlled with high accuracy by forming the resin layer 30 on the inner surface 17b of the hole portion 17 of the glass component 10. Even if the shape of the hole portion 17 of the glass component 10 cannot be controlled with high accuracy by an ultrashort pulse laser and etching, the hole 20 of the optical connection component 1 can be formed with high accuracy by covering the inner surface 17b of the hole portion 17 of the glass component 10 with the resin layer 30. Since the hole portion 17 of the glass component 10 can be protected by covering the inner surface 17b of the hole portion 17 of the glass component 10 with the resin layer 30, cracking of the glass component 10 can be made less likely to occur.

The surface roughness of the resin layer 30 may be 1 μm or less. In this case, the shape of the hole 20 of the optical connection component 1 formed by the resin layer 30 can be stabilized. Therefore, the accuracy of positioning when a guide pin or the like is inserted into the hole 20 (for example, the first hole 21) can be enhanced.

The surface roughness of the glass component 10 may be 0.5 μm or more and 10 μm or less. Since the surface roughness of the glass component 10 is 0.5 μm or more, the resin layer 30 can easily adhere to the hole portion 17 of the glass component 10. That is, the adhesion of the resin layer 30 to the inner surface 17b of the hole portion 17 can be enhanced. Since the surface roughness of the glass component 10 is 10 μm or less, the flatness of the hole portion 17 of the glass component 10 can be ensured. Therefore, the occurrence of regions in which the resin layer 30 does not adhere due to unevenness of the inner surface 17b of the hole portion 17 can be reduced.

The thickness of the resin layer 30 may be 30 μm or more and 1000 μm or less. Since the thickness of the resin layer 30 is 30 μm or more, the shape of the hole 20 of the optical connection component 1 can be controlled with high accuracy, and the glass component 10 can be sufficiently protected. Since the thickness of the resin layer 30 is 1000 μm or less, a change in the position of a guide pin or the like inserted into the hole 20 (for example, the first hole 21) of the optical connection component 1 can be more reliably reduced.

When the coefficient of linear expansion of the resin layer 30 is denoted by α [/°C], a relationship between the thickness l₀ of the resin layer 30 and the amount of change Δl in resin thickness due to a temperature rise ΔT [°C] is expressed by the following Equation (1).

Δl=l₀αΔT [Equation 1]

Assuming that the coefficient of linear expansion α of the resin layer 30 is 100×10⁻⁶ [/°C] and the temperature rise ΔT is 100 [°C], according to Equation (1), the amount of change Δl in resin thickness is 1 [μm] when the thickness l₀ of the resin layer 30 is 100 [μm], the amount of change Δl in resin thickness is 0.5 [μm] when the thickness l₀ of the resin layer 30 is 50 [μm], and the amount of change Δl in resin thickness is 0.1 [μm] when the thickness l₀ of the resin layer 30 is 10 [μm]. In an IC for CPO, an accuracy of approximately 0.5 [μm] is required as the positional accuracy of an optical fiber. In this case, by setting the thickness l₀ of the resin layer 30 to 50 [μm] or less, the amount of change Δl in resin thickness when a change in temperature occurs can be set to 0.5 [μm] or less.

The coefficient of linear expansion of the resin layer 30 may be 3×10⁻⁶ [/°C] or more and 100×10⁻⁶ [/°C] or less. In this case, thermal expansion of the optical connection component 1 is prevented, so that the positional accuracy of the optical connection component 1 by a guide pin or the like can be enhanced.

In the method for manufacturing an optical connection component according to the present embodiment, in the step of forming the resin layer, the resin layer 30 may be formed on the inner surface 17b by insert molding. In this case, the resin layer 30 can be easily formed on the inner surface 17b of the hole portion 17 of the glass component 10.

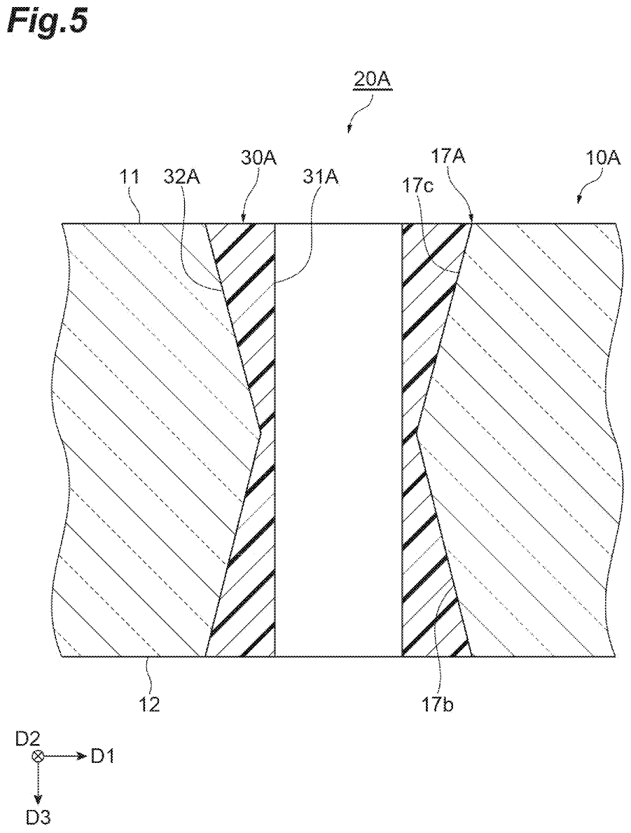

Hereinafter, optical connection components according to modification examples will be described. A portion of the configurations of the optical connection components according to the modification examples to be described later is the same as a portion of the configuration of the optical connection component 1 described above. Hereinafter, the same configurations as those already described are denoted by the same reference signs, and descriptions thereof will be omitted as appropriate. FIG. 5 is a cross-sectional view illustrating a glass component 10A, a hole 20A, and a resin layer 30A of an optical connection component according to a modification example. As illustrated in FIG. 5, the inner surface 17b of a hole portion 17A of the glass component 10A has an inclined portion 17c inclined with respect to the third direction D3.

The inclined portion 17c is inclined with respect to the third direction D3 such that, as viewed along the third direction D3, the area of the hole portion 17A decreases as the hole portion 17A extends away from the front surface 11 of the glass component 10A. In a cross-section taken along a plane extending in the first direction D1 and the third direction D3, a pair of the inclined portions 17c are inclined with respect to the third direction D3 so as to approach each other as the pair of inclined portions 17c extend away from the front surface 11 in the third direction D3.

In a cross-section taken along a plane extending in the first direction D1 and the third direction D3, a pair of inclined portions 17b are inclined with respect to the inclined portions 17c so as to approach each other as the pair of inclined portions 17b extend away from the back surface 12 in a direction opposite to the third direction D3. Therefore, in the cross-section, the distance between the pair of inclined portions 17b in the first direction D1 decreases as the pair of inclined portions 17b approach the center of the glass component 10A in the third direction D3. For example, the shape of the hole portion 17A in the cross-section is an hourglass shape.

The resin layer 30A has an inner surface 31A that is the inner surface of the resin layer 30A as the resin layer 30A is viewed along the third direction D3, and an outer surface 32A that is in contact with the inclined portions 17c. The inner surface 31A extends in the third direction D3. In a cross-section taken along a plane extending in the first direction D1 and the third direction D3, the inner surface 31A extends linearly in the third direction D3. The inner surface 31A has, for example, a circular column shape.

As described above, in the optical connection component including the resin layer 30A according to the modification example, the inner surface 17b of the hole portion 17A of the glass component 10A is inclined with respect to the third direction D3 such that, as viewed along the third direction D3, the area of the hole portion 17A decreases as the hole portion 17A extends away from the front surface 11. The inner surface 31A of the resin layer 30A extends in the third direction D3. In this case, even if the inner surface 17b of the hole portion 17A of the glass component 10A is inclined with respect to the third direction D3, the inner surface 31A of the resin layer 30A covering the hole portion 17A extends in the third direction D3. Therefore, the shape of the hole 20A of the optical connection component can be controlled such that the hole 20A extends in the third direction D3. That is, even if the hole portion 17A having an hourglass shape is formed by etching, the hole 20A having a circular column shape can be formed by resin coating.

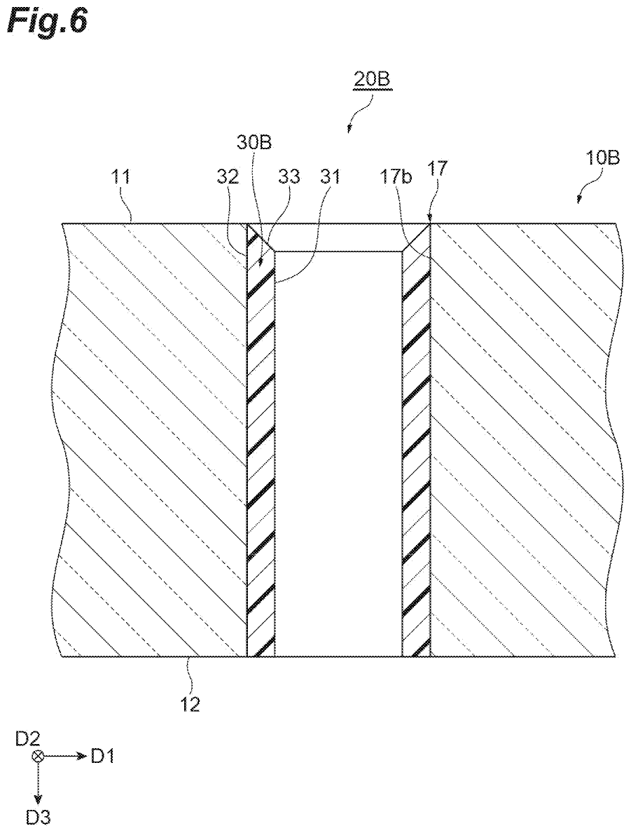

FIG. 6 is a cross-sectional view illustrating a glass component 10B, a hole 20B, and a resin layer 30B of an optical connection component according to a modification example different from that of FIG. 5. As illustrated in FIG. 6, in the optical connection component having the hole 20B according to the modification example, the resin layer 30B has a tapered surface 33 that is a portion inclined with respect to the third direction D3. The tapered surface 33 is inclined with respect to the third direction D3 such that, as viewed along the third direction D3, the area of the inner surface 31 of the resin layer 30B decreases as the resin layer 30B extends away from the front surface 11 of the glass component 10B.

In a cross-section taken along a plane extending in the first direction D1 and the third direction D3, a pair of the tapered surfaces 33 are inclined with respect to the third direction D3 so as to approach each other as the pair of tapered surfaces 33 extend away from the front surface 11 in the third direction D3. Therefore, in the cross-section, the distance between the pair of tapered surfaces 33 in the first direction D1 decreases as the pair of tapered surfaces 33 extend away from the front surface 11 in the third direction D3.

In the optical connection component having the hole 20B according to the modification example, the resin layer 30B has the tapered surface 33 that is a portion inclined with respect to the third direction D3 such that, as viewed along the third direction D3, the area of the inner surface 31 of the resin layer 30B decreases as the resin layer 30B extends away from the front surface 11. In this case, since the area of the inner surface 31 of the resin layer 30B increases as the resin layer 30B approaches the front surface 11, a guide pin or the like can be easily inserted into the hole 20B from the front surface 11.

The embodiments and various modification examples of the optical connection component and the method for manufacturing an optical connection component according to the present disclosure have been described above. However, the optical connection component and the method for manufacturing an optical connection component according to the present disclosure are not limited to the embodiments and the modification examples described above, and may be further modified within the scope of the concept described in the claims. The shapes, sizes, materials, numbers, and disposition modes of the respective parts of the optical connection component, as well as the contents and order of the steps of the method for manufacturing an optical connection component, can be changed as appropriate within the scope of the concept. It should be understood that at least one configuration or feature described in the embodiments and the modification examples described above can be combined with other embodiments and modification examples, or can be variously modified.

For example, in the embodiment described above, the optical connection component 1 having the hole 20 penetrating through the glass component 10 in the third direction D3 has been described. However, the hole may not penetrate through the glass component in the third direction. That is, the optical connection component may have a hole that does not penetrate through the glass component in the third direction.

What is claimed is:

1. An optical connection component comprising:
a glass component having a front surface extending in a first direction and a second direction intersecting the first direction,
wherein the glass component has a hole portion recessed from the front surface in a third direction intersecting the first direction and the second direction, and
the optical connection component comprises a resin layer formed on an inner surface of the glass component that defines the hole portion.

2. The optical connection component according to claim 1,
wherein an inner surface of the hole portion of the glass component is inclined with respect to the third direction such that, as viewed along the third direction, an area of the hole portion decreases as the hole portion extends away from the front surface, and
an inner surface of the resin layer extends in the third direction.

3. The optical connection component according to claim 1,
wherein the resin layer has a tapered surface that is a portion inclined with respect to the third direction such that, as viewed along the third direction, an area of the inner surface of the resin layer decreases as the resin layer extends away from the front surface.

4. The optical connection component according to claim 1, wherein a surface roughness of the resin layer is 1 μm or less.

5. The optical connection component according to claim 1,
wherein a surface roughness of the glass component is 0.5 μm or more and 10 μm or less.

6. The optical connection component according to claim 1,
wherein a thickness of the resin layer is 30 μm or more and 1000 μm or less.

7. The optical connection component according to claim 1,
wherein a coefficient of linear expansion of the resin layer is 3×10⁻⁶ [/°C] or more and 100×10⁻⁶ [/°C] or less.

8. A method for manufacturing an optical connection component, the method comprising:
a step of forming a hole portion recessed from a front surface of a glass component by irradiating the glass component with an ultrashort pulse laser; and
a step of forming a resin layer on an inner surface defining the hole portion.

9. The method for manufacturing an optical connection component according to claim 8,
wherein in the step of forming the resin layer, the resin layer is formed on the inner surface by insert molding.
